(19) United States
(12) Patent Application Publication
(10) Pub. No.: US 2024/0412473 A1
(43) Pub. Date: Dec. 12, 2024

(54) SIGNAL-TRIGGERED AI GENERATION OF VIRTUAL ENVIRONMENT ENHANCEMENT

(71) Applicant: INTERNATIONAL BUSINESS MACHINES CORPORATION, ARMONK, NY (US)

(72) Inventors: Manana Hakobyan, San Jose, CA (US); Steven Lee Fisher-Stawinski, Buffalo Grove, IL (US); Scott E. Schneider, Rolesville, NC (US); Brian Patrick Hanley, Ann Arbor, MI (US)

(21) Appl. No.: 18/332,178

(22) Filed: Jun. 9, 2023

(51) Int. Cl. G06T 19/20; G06N 3/0475; G06T 15/08

(52) U.S. Cl. CPC G06T 19/20; G06N 3/0475; G06T 15/08; G06T 2210/62; G06T 2219/2012; G06T 2219/2016

(57) ABSTRACT

A method, a computer system, and a computer program product for virtual environment enhancement are provided. A signal is determined from one or more events in a virtual environment. In response to the determined signal triggering virtual environment enhancement, a request based on the determined signal is input to at least one generative artificial intelligence model that in response produces media content. The media content is presented within the virtual environment such that the media content includes one or more distinguishing sensory attributes distinguishing the media content from remaining portions of the virtual environment.

### BACKGROUND

The present invention relates generally to virtual shared environments, artificial intelligence for sensing events in virtual shared environments, and artificial intelligence for producing media content to enhance virtual shared environments.

### SUMMARY

A method is provided for virtual environment enhancement. A signal is determined from one or more events in a virtual environment. In response to the determined signal triggering virtual environment enhancement, a request based on the determined signal is input to at least one generative artificial intelligence model that in response produces media content. The media content is presented within the virtual environment such that the media content includes one or more distinguishing sensory attributes distinguishing the media content from remaining portions of the virtual environment. A computer system and a computer program product corresponding to this method are also provided herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a virtual environment with a virtual environment enhancement according to at least one embodiment;

FIG. 2 illustrates the virtual environment with another virtual environment enhancement according to at least one embodiment;

FIG. 3 illustrates the virtual environment with another virtual environment enhancement according to at least one embodiment;

FIG. 4 illustrates the virtual environment with another virtual environment enhancement according to at least one embodiment;

FIG. 5 illustrates a virtual environment with another virtual environment enhancement according to at least one embodiment;

FIG. 6 illustrates enhancement mode notification that according to at least one embodiments may occur in one or more of the virtual environments described previously with respect to FIGS. 1-5;

FIG. 7 is an operational flowchart illustrating a virtual environment enhancement process according to at least one embodiment which may, for example, be carried out as depicted in one or more of FIGS. 1-6; and

FIG. 8 is a block diagram illustrating a computer environment with multiple computer systems in which the virtual environment enhancements described in the other drawings may be carried out.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present embodiments include a computer-implemented method for virtual environment enhancement. A signal is determined from one or more events in a virtual environment. In response to the determined signal triggering virtual environment enhancement, a request based on the determined signal is input to at least one generative artificial intelligence model that in response produces media content. The media content is presented within the virtual environment such that the media content includes one or more distinguishing sensory attributes distinguishing the media content from remaining portions of the virtual environment. In this manner, virtual presentations within a virtual environment are enhanced in a sensorily distinct manner so that observants can recognize the enhancements as presentation enhancements instead of continually persisting virtual environment structure.

In additional embodiments, the media content includes volumetric content and the presenting includes displaying the volumetric content within the virtual environment. In this manner, virtual presentations within a virtual environment are enhanced in a sensorily distinct manner relevant for the sense of vision so that observants can visually recognize the enhancements as presentation enhancements instead of continually persisting virtual environment structure.

In additional embodiments, the one or more distinguishing sensory attributes of a volumetric content that is media content as a virtual environment enhancement include one or more of a transparency factor, a scaling factor, a location factor, and a color factor. In this manner, presentation details are included to help a virtual environment participant better visually recognize enhancements as mere presentation enhancements instead of continually persisting virtual environment structure.

In additional embodiments, the one or more distinguishing sensory attributes of a volumetric content as a virtual environment enhancement include a transparency factor of the volumetric content that is different from a transparency factor of portions of the virtual environment surrounding the volumetric content. In this manner, presentation details are included to use light transmission qualities of a virtual object to help a virtual environment participant better visually recognize enhancements as mere presentation enhancements instead of continually persisting virtual environment structure.

In additional embodiments, the one or more distinguishing sensory attributes of a volumetric content as a virtual environment enhancement include a scaling factor of the volumetric content that is higher or lower than a scaling factor of elements of the virtual environment surrounding the volumetric content. In this manner, size aspects of 3D objects are used to help a virtual environment participant better visually recognize enhancements as mere presentation enhancements instead of continually persisting virtual environment structure.

In additional embodiments, the one or more distinguishing sensory attributes of a volumetric content as a virtual environment enhancement include a location factor of the volumetric content such that the volumetric content is displayed within a visually demarcated portion of the virtual environment that separates the volumetric content from the remaining portions of the virtual environment. In this manner, virtual positioning aspects of a 3D object are used to help a virtual environment participant better visually recognize enhancements as mere presentation enhancements instead of continually persisting virtual environment structure.

In additional embodiments, the visually demarcated portion of volumetric content as a virtual environment enhancement includes a thought bubble associated with one or more characters within the virtual environment. In this manner, socially understood structure is used for positioning a 3D object to help a virtual environment participant better visually recognize enhancements as mere presentation enhancements instead of continually persisting virtual environment structure.

In additional embodiments, the media content that is presented as a virtual environment enhancement changes over time during the presenting. In this manner, advanced enhancements are used to better enhance a presentation occurring within a virtual environment while still helping a virtual environment participant better visually recognize the enhancements as mere presentation enhancements instead of continually persisting virtual environment structure.

In additional embodiments, the media content that is presented as a virtual environment enhancement and that includes one or more sensory distinguishing attributes includes audio content. In this manner, alternative sensory content of hearing is used to help a virtual environment participant better recognize the enhancements as mere presentation enhancements instead of continually persisting virtual environment structure.

In additional embodiments, responsive to identifying a second predetermined signal, the media content is revoked. A third signal from the virtual environment is detected and decoded. The media content is evolved based on the third signal and thereby produces first evolved media content. The first evolved media content shares one or more elements with the revoked media content. The first evolved media content is presented within the virtual environment such that the first evolved media content includes one or more distinguishing sensory attributes distinguishing the first evolved media content from remaining portions of the virtual environment. In this manner, versatility of media content generation is achieved to allow a virtual environment presenter increased control over virtual environment enhancements used to enhance a virtual presentation.

In additional embodiments, the presentation of the media content is placed within the virtual environment based on the determined signal. In this manner, signal analysis techniques are implemented to allow a virtual environment presenter increased control over virtual environment enhancements used to enhance a virtual presentation.

In additional embodiments, the media content presented in the virtual environment includes a volumetric content and the presenting includes a display of the volumetric content within the virtual environment. The placement of the presentation includes a location placement of the volumetric content within the virtual environment. In this manner, signal analysis techniques are implemented to allow a virtual environment presenter increased control over virtual environment visible enhancements used to visibly enhance a virtual presentation.

In additional embodiments, the media content as a virtual environment enhancement presented in the virtual environment includes audio content and the presenting includes playing of the audio for the virtual environment. A placement of the presentation includes one or more of a location placement for dissemination of the audio content within the virtual environment, a timing placement for the audio content, and a pitch placement for the audio content. In this manner, alternative sensory content of hearing is used to help a virtual environment participant better recognize the enhancements as mere presentation enhancements instead of continually persisting virtual environment structure.

In additional embodiments, the media content as a virtual environment enhancement is presented in a default location placement within the virtual environment. In this manner, preprogramming is used to compensate for lack of input details regarding presentation of virtual environment enhancements that enhance a virtual presentation within a virtual world.

In additional embodiments, the one or more distinguishing sensory attributes of the presented media content match a message that was presented within the virtual environment and that indicated the one or more distinguishing sensory attributes. In this manner, increased control and understanding of virtual participants within a virtual shared environment are achieved via virtual communication techniques.

In additional embodiments, the one or more events in the virtual environment is one or more of audio, a movement, virtual environment character interaction, and virtual environment metadata. In this manner, data analysis techniques are harnessed to determine when virtual environment enhancement is desired to occur within the virtual environment.

In additional embodiments, a computer system and a computer program product for virtual environment enhancement are provided and are capable of causing a processor to perform the above-described methods to achieve the above-described advantages.

The following described exemplary embodiments provide a method, computer system, and computer program product for using artificial intelligence to enhance shared virtual environments. Society is pivoting towards use of collective shared virtual spaces to perform social interaction for a variety of pursuits related to personal recreation, education, governing, business, etc. Using such virtual spaces reduces travel requirements for in-person interactions. For these virtual environments, technical challenges from the physical world become less of a barrier. In the physical world, media content is traditionally delivered to and presented on special-purpose surfaces such as televisions and mobile displays. Immersive integration with the user is difficult for these traditional media deliveries. Virtual shared environments better achieve immersion for users, but seamless integration of personalized, highly responsive, contextual content has been a past goal. Consumer expectations for a virtual environment to facilitate personalized content, increased immersion, and speedy transmission and/or generation of content demands tremendous effort and high costs to content providers. Distinguishing between genuine objects in a virtual environment from transient enhancement media presentation might inspire malicious actors and impose a security risk to users. The present embodiments use software and artificial intelligence to produce signal-triggered artificial intelligence generation of virtual environment enhancements which have distinguishing sensory attributes that help the virtual shared environment users to distinguish these enhancements from remaining portions of the virtual environment. In at least some embodiments the virtual environment enhancements take the form of a generative volumetric overlay that is infused into the collective shared virtual space. The present embodiments therefore achieve enhancement of the virtual experience with advances in media presentation and security.

The achievement of the present embodiments of virtual environment enhancements which have distinguishing sensory attributes and which may be generative volumetric overlays allow users to share a story that plays out with additional visual and/or sound content that is presented and infused into the collective shared virtual space. Sensors within the virtual environment are able to sense events that occur such as spoken words and/or dialogue and/or virtual movements within the virtual environment. Based on the sensing of certain signals from such events, the present embodiments include the artificial intelligence generation of media content that supplements the trigger events and helps achieve a more robust virtual experience. The virtual environment enhancements such as the generative volumetric overlays facilitate presentation, e.g., projection, of the media content enhancements within the virtual environment, e.g., of the three-dimensional virtual environment. The enhancements are based off the sensed triggering signals such as a story being told by a virtual shared environment participant. The identification of the triggering signals triggers artificial intelligence to generate media content that is based on the triggering events, evolves with the triggering events, and is customizable and distinguishable from the remaining portions of the virtual environment. The present embodiments may help achieve more effective and interactive education, increased efficiency in pitching new ideas, and new opportunities for better capturing the attention of others within the collective shared virtual space.

The virtual environment enhancement as described herein includes one or more distinguishing sensory attributes distinguishing the media content from remaining portions of the virtual environment. The media content includes volumetric visual content and/or audio content. The one or more distinguishing sensory attributes of the volumetric content include one or more of a transparency factor, a scaling factor, a location factor, and a color factor that is distinct from the factors of other elements that appear visually and/or audibly within the virtual shared environment. For example, a volumetric content is generated with a color scheme that is unique and contrasts with the color of surrounding elements within the virtual shared environment. For example, a three-dimensional projection is generated with a neon color while no other element in the vicinity within the virtual environment includes a neon color. The distinct color helps virtual environment participants recognize that the virtual environment enhancement is being presented to supplement the one or more events such as a presentation being provided/story being told instead of being a standard portion of the virtual environment.

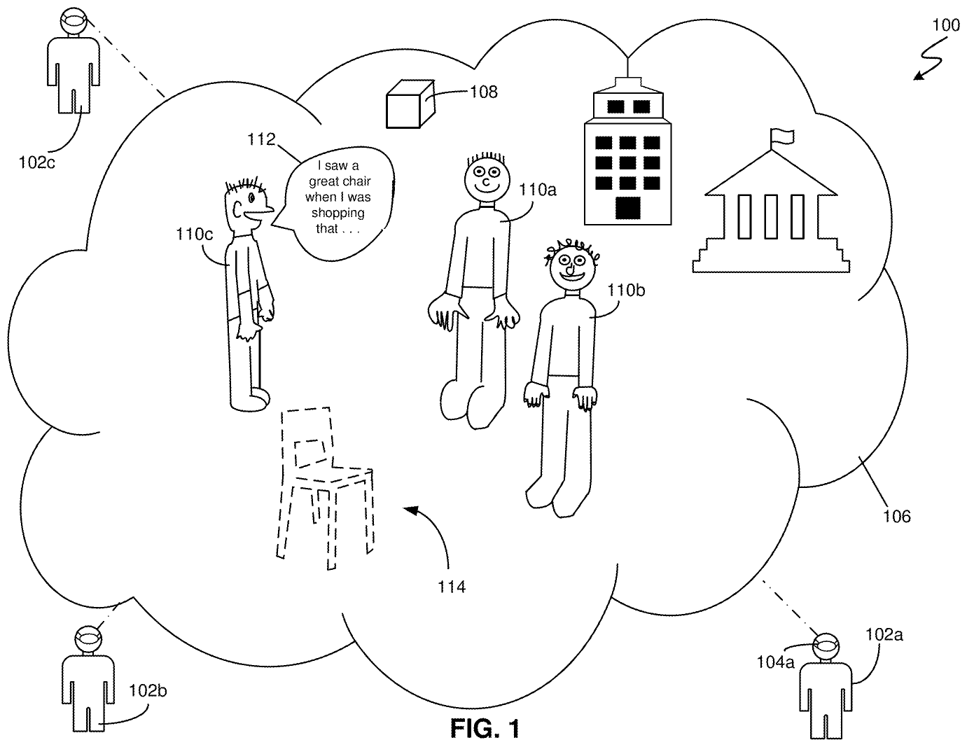

FIG. 1 illustrates a first enhanced virtual environment scene 100 in which a virtual environment enhancement with one or more distinguishing sensory attributes is presented. One or more events within the virtual environment are sensed and a trigger signal causes artificial intelligence to generate and present supplementary media content which supplements the one or more sensed events. FIG. 1 illustrates that first, second, and third users 102a, 102b, 102c, respectively, are using first, second, and third virtual headsets 104a, 104b, and 104c, respectively, to enter into and participate in a first virtual shared environment 106. The virtual headsets include a display screen and audio speakers but also microphones, cameras, motion sensors, infrared LEDs, sensing gloves, full body sensor suits, treadmills, joysticks, motion trackers, and/or tactile sensors, etc. to receive input from the physical user and translate that input into appropriate impact (e.g., sound or movement) for the respective virtual shared environment. A first avatar 110a represents the first user 102a within the first virtual shared environment 106. A second avatar 110b represents the second user 102b within the first virtual shared environment 106. A third avatar 110c represents the third user 102c within the first virtual shared environment 106. A virtual sensor 108 that is part of the first virtual shared environment 106 monitors multimodal input from the first virtual shared environment 106. The virtual sensor 108 uses the multimodal input to monitor events such as movements, spoken word, dialogue, and virtual environmental changes within the first virtual shared environment 106. The virtual sensor 108 is configured to detect virtual environment events, to record the events, and then to decode a semantic meaning of the events.

For virtual environment enhancement in the first enhanced virtual environment scene 100 shown in FIG. 1, the virtual sensor 108 senses that the third avatar 110c is telling a story, e.g., about a recent experience that the third avatar 110c and/or the third user 102c experienced. The third avatar 110c speaks first words 112 within the first virtual shared environment 106 describing a chair that the third avatar 110c and/or the third user 102c saw while shopping. The virtual sensor 108 includes a word sensing component such as a virtual microphone which can record words spoken within the first virtual shared environment 106 and/or includes a virtual camera which can read words presented visually within the first virtual shared environment 106. In some embodiments, the virtual sensor 108 performs speech-to-text transcription on captured words spoken within the first virtual shared environment 106. In at least some embodiments, the virtual sensor 108 itself or another aspect of the virtual environment enhancement program 816 performs natural language processing on the captured words. In at least some embodiments, the virtual environment enhancement program 816 uses input analysis techniques based on a type of input (e.g., text, audio, images, videos, and/or metadata) and/or based on any events detected. The virtual environment enhancement program 816 performs, on input received via the virtual sensor 108, one or more of various analysis techniques such as speech-to-text, handwriting/typing/text analysis for natural language processing, facial recognition (for users who have provided legal and informed consent for same for themselves and/or for a depiction of their avatar that represents them in the virtual environment), gesture recognition using computer visions and/or a dedicated controller for motion detection, and brain computer interface based on electroencephalography.

In some embodiments, the virtual sensor 108 inputs the captured words and/or the natural language processing output produced from the captured words into a machine learning model associated with the first virtual shared environment 106. The machine learning model as output produces an indication that the words constitute a trigger signal for producing supplemental media content to supplement the event (the event in this case is the third avatar 110c telling a story about seeing the chair). Based on the monitored information being designated as trigger information, the collected information related to the event is input into artificial intelligence which in response generates and/or yields media content related to the event. FIG. 1 shows that the artificial intelligence generated a virtual environment enhancement that is volumetric content of a transparent first chair 114 that is presented within the first virtual shared environment 106 so as to be visible to various participants such as the first, second, and/or third avatars 110a, 110b, 110c within the first virtual shared environment 106. In at least some embodiments the artificial intelligence media content generator itself produces a standard media content suitable for presentation in the virtual environment and then the standard media content is supplemented by a sensory distinguishing module of the virtual environment enhancement program 816 that applies a sensory distinguishing attribute to the standard media content. The transparent first chair 114 is presented with a distinguishing sensory attribute of a higher transparency factor compared to the other portions of the first virtual shared environment 106 that are being presented therein.

The dotted lines used in FIG. 1 to depict the transparent first chair 114 are used to indicate the increased transparency factor. The increased transparency of the transparent first chair 114 (compared to other nearby portions of virtual environment) helps the virtual environment participants recognize that this enhancement is a supplemental content enhancement and not a structured portion of the first virtual shared environment 106. In at least some embodiments the artificial intelligence media content generator itself produces an image of the chair with a normal transparency and then the sensory distinguishing module of the virtual environment enhancement program 816 applies the increased transparency factor to the non-transparent initial chair image.

In other embodiments, surrounding portions of the virtual environment all included a higher transparency and the generated enhancement chair is non-transparent so that the non-transparent chair is sensorily distinct.

Due to the increased transparency of the transparent first chair 114, the first and second avatars 102a, 102b better are able to recognize that they should not virtually sit on the transparent first chair 114 but instead that this transparent first chair 114 is being presented within the first virtual shared environment 106 in order to help illustrate the story that is being told by the third avatar 110c. In other embodiments, the enhancements such as the transparent first chair 114 allow virtual interaction with participants within the respective virtual shared environment. For example, in other embodiments if the third avatar 110c is describing physical aspects of the transparent first chair 114 one of the other avatars is able to virtually sit on the transparent first chair 114 in order to better appreciate the description that is being given by the third avatar 110c. The virtual reality equipment used by a user to participate in the virtual environment in some embodiments include one or more tactile sensors which provide feedback to mimic the physical sensation that would be present if the user were physical engaging (e.g., sitting on) such a chair in the physical world.

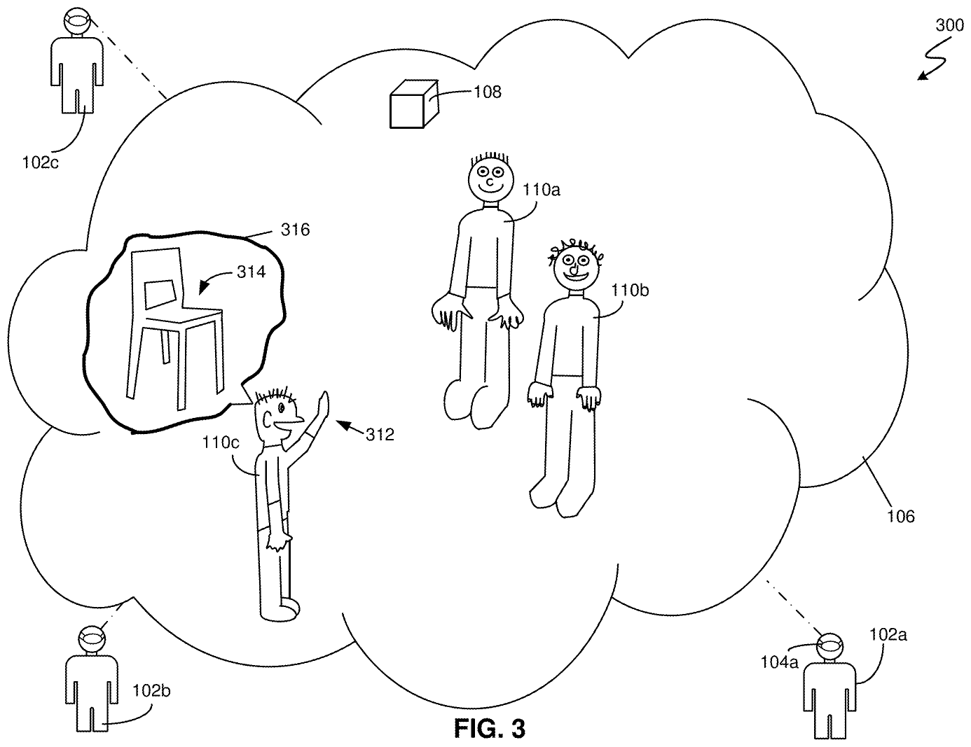

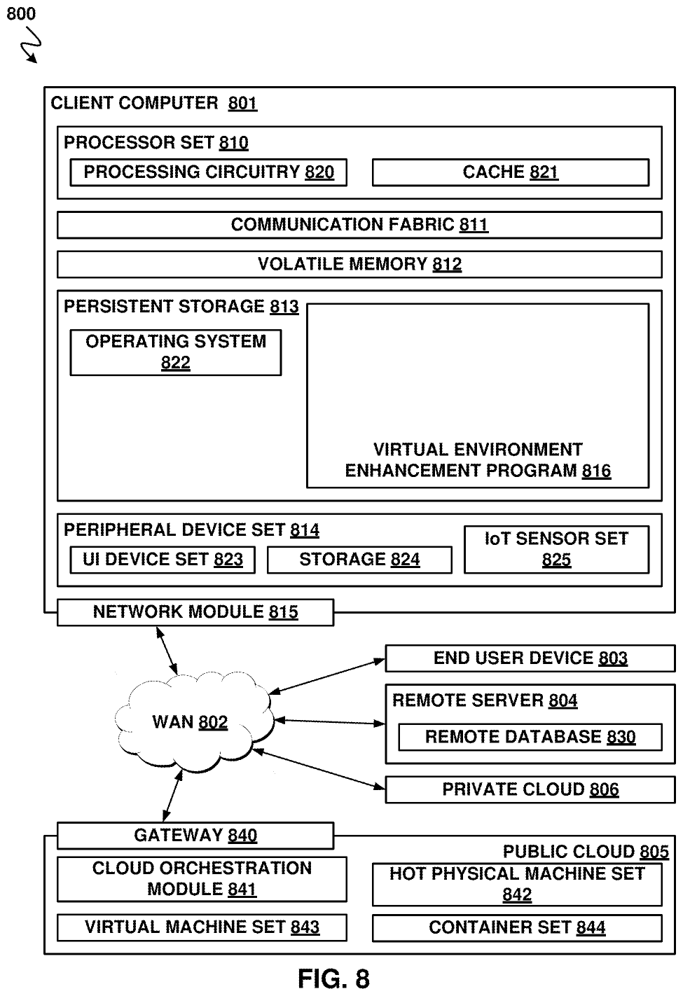

FIG. 1 illustrates an example in which the signal determined from one or more events within the first virtual shared environment 106 is a textual signal that includes text from words that are spoken and/or otherwise presented within the first virtual shared environment 106. In other embodiments, the signals determined and the events monitored include other aspects besides text that is presented within the respective virtual shared environment. For example, FIG. 3 illustrates that a virtual movement (e.g., first gesture 312) of an avatar within the respective virtual space is an event whose detection triggers virtual environment enhancement generation. In some embodiments, virtual environment movements of one or more avatars and/or other components of the respective virtual shared environment constitute the events whose detection (via determining signals) triggers virtual environment enhancement. Virtual environment movements of one or more avatars and/or other components of the respective virtual shared environment constitute the events whose detection (via determining of signals) triggers virtual environment enhancement according to some embodiments. Virtual environment changes over time constitute the events whose detection (via determining of signals) triggers virtual environment enhancement according to some embodiments. Such virtual environment changes include virtual environment changes that occur according to various patterns such as mimicking the light and weather changes of a day and night in the physical world. In such embodiments, the virtual environment enhancement program 816 shown in FIG. 8 receives signals from virtual sensors and/or from virtual environment metadata to indicate these other types of events which trigger virtual environment enhancement creation and presentation.

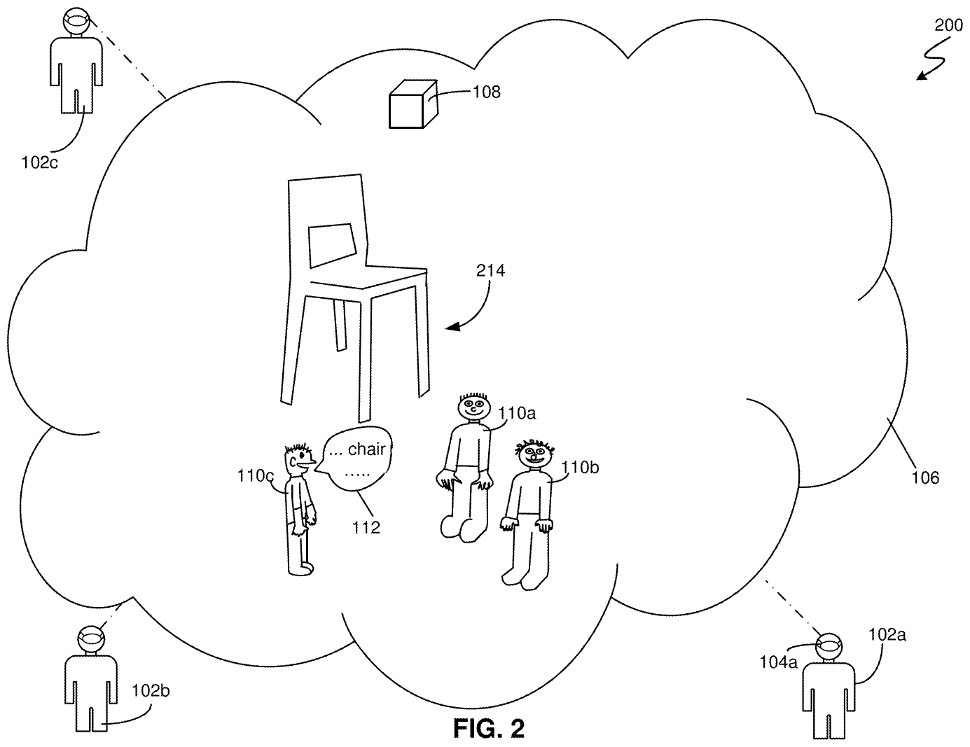

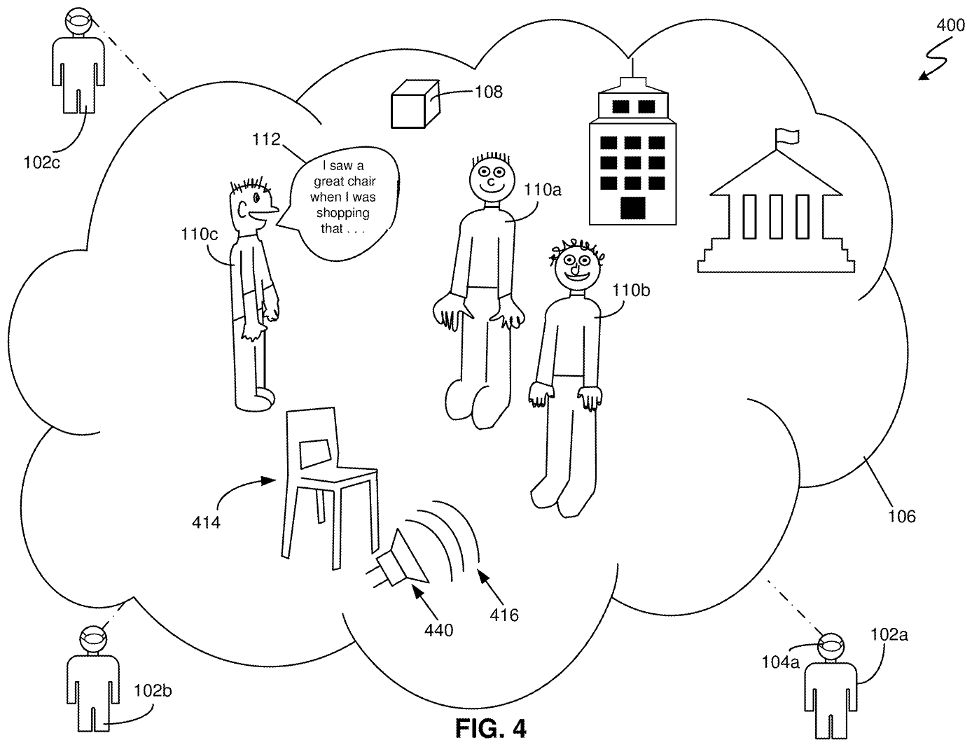

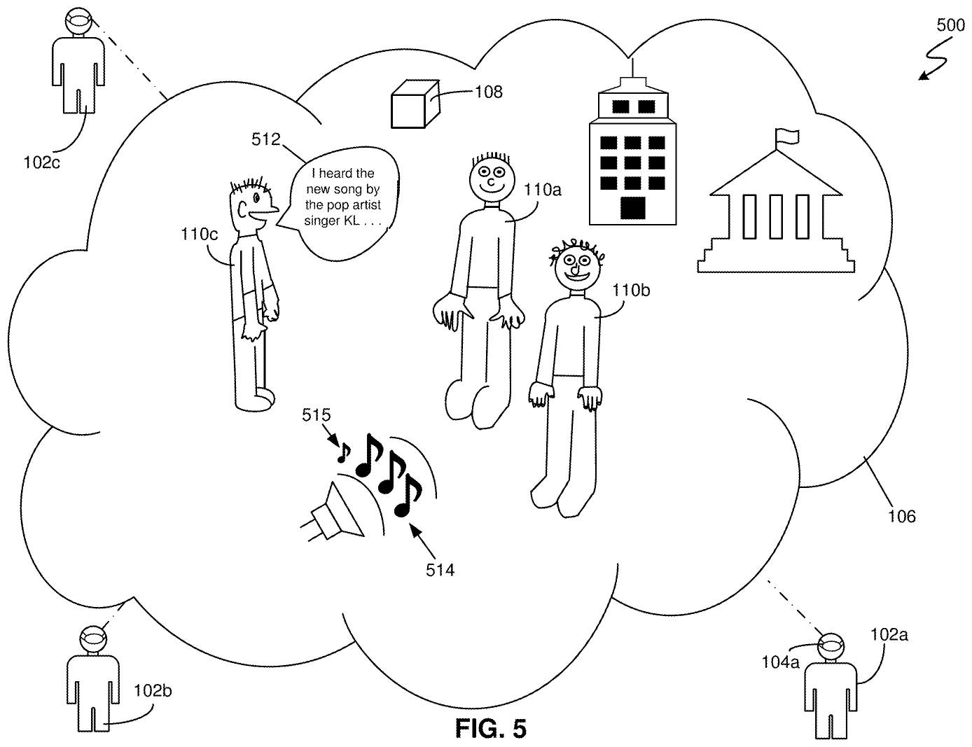

FIG. 1 illustrates that the virtual environment enhancement is a generative volumetric overlay (e.g., transparent first chair 114) that is overlaid over other visual presentation within the virtual environment. Other embodiments additionally or alternatively use other forms of distinguishing sensory attributes for the generated media content that enhances one or more sensed events. For example, FIG. 2 shows generative volumetric overlay that includes a scaling factor for using size to distinguish the enhancement content as compared to other portions of the virtual environment. FIG. 3 shows generative volumetric overlay that includes a location factor for distinguishing the enhancement content as compared to other portions of the virtual environment. FIG. 4 shows generative volumetric overlay that also includes an audio factor for distinguishing the enhancement content as compared to other portions of the virtual environment. FIG. 5 depicts a virtual environment enhancement that is an audio component without an additional generative volumetric overlay. The audio component alone in that embodiment of FIG. 5 achieves the sensory distinguishing for distinguishing the enhancement content as compared to other portions of the virtual environment.

In some embodiments, a user preconfigures with the virtual environment enhancement program 816 particular text such as one or more wake-up words to trigger voice recording/text monitoring for monitoring of the words provided in the virtual shared environment. The monitoring can find suitable text content for virtual environment enhancement generation with one or more distinguishing sensory attributes. In some embodiments, a user preconfigures with the virtual environment enhancement program 816 particular text such as one or more trigger words whose subsequent detection in the virtual environment triggers generation of particular virtual environment enhancement content with distinguishing sensory attributes. In some embodiments, a user presents various words and stores particular media content for each respective word or set of words. In some embodiments, the virtual environment enhancement program 816 generates a graphical user interface with which a user interacts using a computer such as the client computer 801 shown in FIG. 8. The user navigates the graphical user interface to store one or more words and accompanying respective media content to present within a virtual environment in response to one or more sensors within the virtual environment sensing presentation of the one or more trigger words. An embodiment with a look-up table matching media content with particular sensed events/words constitutes a simplified embodiment that does not require a machine learning model to analyze all of the monitored input (although natural language processing can still be performed on the text in that embodiment).

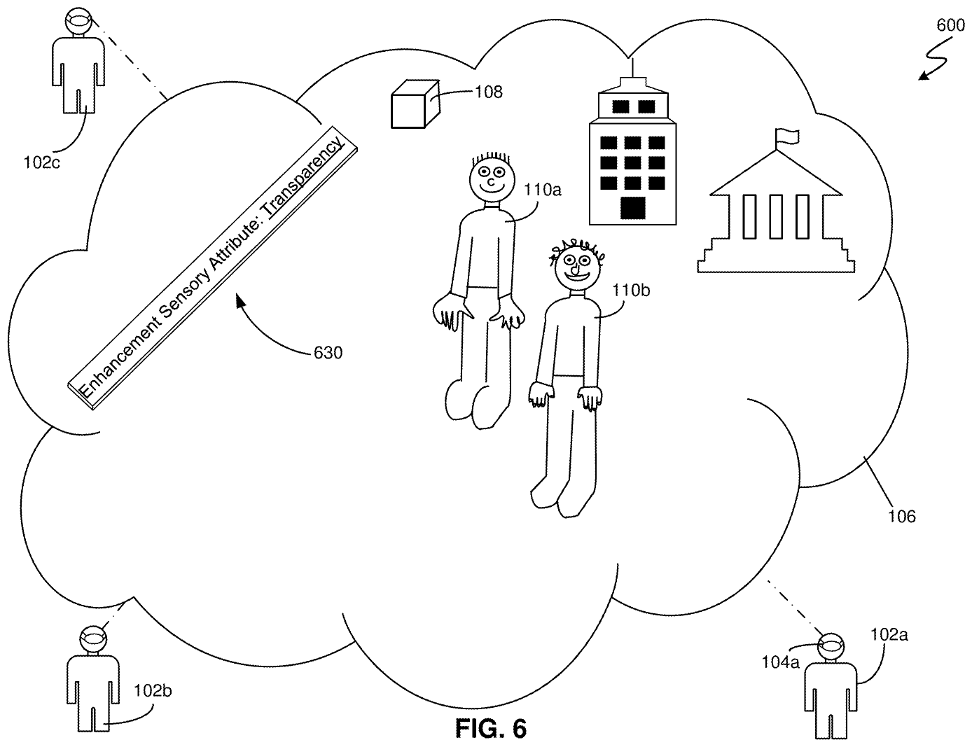

In some embodiments, a word for waking the text monitoring of the virtual environment enhancement program 816 is publicly shared within the virtual environment for various avatars and/or other virtual environment participants to use for triggering the virtual environment enhancement with one or more distinguishing sensory attributes. For example, in some embodiments the wake word is publicly presented within the shared virtual space so that any virtual space participant who desires can use the wake word to trigger the virtual environment enhancement. FIG. 6 shows an example of this embodiment. In other embodiments, a user-specific wake message (e.g., wake word and/or wake gesture) is provided by the virtual environment enhancement program 816 and is not broadcast publicly throughout the virtual shared environment. By not sharing this user-specific wake word publicly, the virtual environment enhancement program 816 is more likely able to preserve customized enhancements prepared by a particular user so that the customized enhancements only or primarily are triggered and used by the particular user instead of by other virtual environment participants.

In some embodiments, a wake action is associated with particular media content for the virtual environment enhancement. In other embodiments, a wake action triggers the virtual environment enhancement program 816 to begin to monitor the shared content within the virtual shared environment so that contextual clues from the one or more events (such as words shared) within the virtual shared environment are captured and analyzed to determine appropriate virtual environment enhancements to generate and present to supplement and enhance the one or more events, e.g., to illustrate a story that is being verbally told.

FIG. 2 illustrates a second enhanced virtual environment scene 200 in which a virtual environment enhancement with one or more distinguishing sensory attributes is presented. The second enhanced virtual environment scene 200 includes many components that are shared with the first enhanced virtual environment scene 100 so that many common reference numerals are used in both FIG. 1 and in FIG. 2. The same virtual shared environment 106 is depicted in both FIGS. 1 and 2, although some individual components within the respective virtual shared environment have changed which is consistent with the regularly changing nature of a virtual shared environment.

For virtual environment enhancement in the second enhanced virtual environment scene 200 shown in FIG. 2, the virtual sensor 108 and the virtual environment enhancement program 816 sense that the third avatar 110c is again telling a story about a recent experience that the third avatar 110c and/or the third user 102c experienced. The virtual sensor 108, one or more machine learning models, an artificial intelligence media content generator, and a sensory distinguishing module work similarly as was described with respect to the first enhanced virtual environment scene 100 shown in FIG. 1. FIG. 2 shows that the artificial intelligence media content generator generated a virtual environment enhancement that is volumetric content of another chair and the sensory distinguishing module adjusted the scaling of the chair to produce an enlarged chair 214 that is presented within the first virtual shared environment 106 so as to be visible to various participants such as the first, second, and/or third avatars 110a, 110b, 110c within the first virtual shared environment 106. The enlarged chair 214 is presented with a distinguishing sensory attribute of a higher scaling factor compared to the other portions of the first virtual shared environment 106 that are being presented therein. FIG. 2 shows that the enlarged chair 214 is larger than the first and second avatars 110a, 110b who are listening to the third avatar 110c tell the story about the chair. In some embodiments, the scaling factor of the virtual environment enhancement is two or more times larger than the scaling factor of other elements shown within the virtual shared environment, e.g., shown within the vicinity of the triggering event that is occurring in the virtual shared environment. In other embodiments, the scaling factor of the virtual environment enhancement is such that the enhancement appears to be smaller than its typical size and is two or more times smaller than the scaling factor of other elements shown within the virtual shared environment, e.g., to other elements shown within the vicinity of the triggering event.

The altered scaling factor of the enlarged chair 214 helps the virtual environment participants recognize that this enhancement is a supplemental content enhancement and not a structured portion of the first virtual shared environment 106. For example, due to the increased size of the enlarged chair 214 the first and second avatars 102a, 102b better are able to recognize that they should not virtually sit on the enlarged chair 214 but instead that this enlarged chair 214 is being presented within the first virtual shared environment 106 in order to help illustrate the story that is being told by the third avatar 110c. In other embodiments, the enhancements such as the enlarged chair 214 allow virtual interaction with participants within the respective virtual shared environment. For example, in other embodiments if the third avatar 110c is describing physical aspects of the enlarged chair 214 one of the other avatars is able to climb up and virtually sit on the enlarged chair 214 in order to better appreciate the verbal description that is being given by the third avatar 110c. The virtual reality equipment used by a user to participate in the virtual environment in some embodiments include one or more tactile sensors which provide feedback to mimic the physical sensation that would be present if the user were physical engaging (e.g., sitting on) such a chair in the physical world.

FIG. 3 illustrates a third enhanced virtual environment scene 300 in which a virtual environment enhancement with one or more distinguishing sensory attributes is presented. The third enhanced virtual environment scene 300 includes many components that are shared with the first and second enhanced virtual environment scenes 100, 200 so that many common reference numerals are used in all of FIGS. 1-2 and FIG. 3. The same virtual shared environment 106 is depicted in all of FIGS. 1-3, although some individual components within the respective virtual shared environment have changed which is consistent with the regularly changing nature of a virtual shared environment.

For virtual environment enhancement in the third enhanced virtual environment scene 300 shown in FIG. 3, the virtual sensor 108 senses that the third avatar 110c is again telling a story about a recent experience that the third avatar 110c and/or the third user 102c experienced. The third avatar 110c performs a first gesture 312 within the first virtual shared environment 106 which indicates to the virtual sensor 108 to display certain additional enhancement media content. The virtual sensor 108 includes a virtual camera which can capture virtual physical movements of the components of the first virtual shared environment 106. The virtual sensor 108 determines that the third avatar 110c performed a movement and the virtual environment enhancement program 816 inputs the captured first gesture 312 into a machine learning model associated with the first virtual shared environment 106. The machine learning model is configured to classify images. The machine learning model as output produces a class of the gesture and an indication (based at least in part on the class) that the first gesture 312 constitutes a trigger signal for producing supplemental media content to supplement the event. The event in this case is the third avatar 110c telling a story about seeing a chair.

In response to the monitored information being designated by the virtual sensors and/or the virtual environment enhancement program 816 as trigger information, the collected information related to the event is input into artificial intelligence which in response generates and/or yields media content related to the event. FIG. 3 shows that the artificial intelligence generated a virtual environment enhancement that is volumetric content of a chair volumetric content 314. The sensory distinguishing module adjusts the produced chair volumetric content so that it is presented within a designated location within the first virtual shared environment 106 so as to be visible to various participants such as the first, second, and/or third avatars 110a, 110b, 110c within the first virtual shared environment 106. The designated location is visually set apart/visually demarcated within the first virtual shared environment 106 so that the designated location is sensorily distinguishable from other portions of the first virtual shared environment 106. In the embodiment depicted in FIG. 3, the designated location that is visually set apart and/or demarcated is an enclosed thought bubble 316 which appears associated with the third avatar 110c as if the enclosed thought bubble 316 illustrates aspects described by the third avatar 110c. FIG. 3 shows the enclosed thought bubble 316 (hosting the chair volumetric content 314) as being positioned above the third avatar 110c; however, in other embodiments the thought bubble is positioned laterally adjacent or next to the third avatar 110c within the virtual shared environment 106. In other embodiments, the designated location is in a set apart, e.g., enclosed, location, in another area that is not adjacent to and/or close to the third avatar 110c within the first virtual shared environment 106. In some embodiments the visual demarcation constitutes a rounded area (such as the enclosed thought bubble 316) but in other embodiment the visual demarcation constitutes a shape with straight lines such as a square or rectangle outline. Other embodiments include combinations of such curved and straight lines for the visual demarcation.

The presentation of the chair volumetric content 314 within the designated location, e.g., within the visually demarcated enclosure such as the enclosed thought bubble 316, helps the virtual environment participants recognize that this enhancement is a supplemental content enhancement and not a typical structured portion of the first virtual shared environment 106. For example, due to the positioning within the designated location the first and second avatars 102a, 102b better are able to recognize that they should not virtually sit on the chair volumetric content 314 but instead that this chair volumetric content 314 is being presented within the first virtual shared environment 106 in order to help illustrate the story that is being told by the third avatar 110c. In other embodiments, the enhancements such as the chair volumetric content 314 within the designated location that is visually demarcated (such as the area within the enclosed thought bubble 316) allow virtual interaction with participants within the respective virtual shared environment. For example, in other embodiments if the third avatar 110c is describing physical aspects of the chair depicted with the chair volumetric content 314 one of the other avatars is able to enter the visually demarcated area, e.g., the enclosed thought bubble 316, and virtually sit on the chair volumetric content 314 in order to better appreciate the description that is being given by the third avatar 110c. The virtual reality equipment used by a user to participate in the virtual environment in some embodiments include one or more tactile sensors which provide feedback to mimic the physical sensation that would be present if the user were physical engaging (e.g., sitting on) such a chair in the physical world.

In some embodiments, a user preconfigures with the virtual environment enhancement program 816 a visual action such as the first gesture 312 to trigger event monitoring such as voice recording/text monitoring for monitoring of the words provided in the virtual shared environment. In some embodiments, a user preconfigures with the virtual environment enhancement program 816 a visual action such as a gesture to trigger generation of particular virtual environment enhancement content with distinguishing sensory attributes. In some embodiments, a user presents various visual actions and stores particular media content for each respective visual action. In some embodiments, the virtual environment enhancement program 816 generates a graphical user interface with which a user interacts using a computer such as the client computer 801 shown in FIG. 8. The user navigates the graphical user interface to store visual actions and accompanying respective media content to present within a virtual environment in response to one or more sensors within the virtual environment sensing a particular visual action. In some embodiments the visual action includes a gesture such as a clap and/or a finger snap.

FIG. 4 illustrates a fourth enhanced virtual environment scene 400 in which a virtual environment enhancement with one or more distinguishing sensory attributes is presented. The fourth enhanced virtual environment scene 400 includes many components that are shared with the first, second, and third enhanced virtual environment scenes 100, 200, 300 so that many common reference numerals are used in all of FIGS. 1-3 and FIG. 4. The same virtual shared environment 106 is depicted in all of FIGS. 1-4, although some individual components within the respective virtual shared environment have changed which is consistent with the regularly changing nature of a virtual shared environment.

For virtual environment enhancement in the fourth enhanced virtual environment scene 400 shown in FIG. 4, the virtual sensor 108 senses that the third avatar 110c is again telling a story about a recent experience that the third avatar 110c and/or the third user 102c experienced. The third avatar 110c speaks first words 112 within the first virtual shared environment 106 describing a chair that the third avatar 110c and/or the third user 102c saw while shopping. The virtual sensor 108 includes a word sensing component such as a virtual microphone and/or a virtual camera which can read words presented visually within the first virtual shared environment 106. The virtual sensor 108 inputs the captured words into a machine learning model associated with the first virtual shared environment 106. The machine learning model as output produces an indication that the first words 112 constitute and/or include a trigger signal for producing supplemental media content to supplement/enhance the virtual event. The event in this case is the third avatar 110c telling a story about seeing the chair. Based on the monitored information being designated as trigger information, the collected information related to the event is input into artificial intelligence which in response generates media content related to the event. FIG. 4 shows that the artificial intelligence generated a virtual environment enhancement that is volumetric content of an audio-accompanied chair 414 that is presented within the first virtual shared environment 106 so as to be visible to various participants such as the first, second, and/or third avatars 110a, 110b, 110c within the first virtual shared environment 106. The sensory distinguishing module supplements the audio-accompanied chair 414 with a distinguishing sensory attribute that is accompanying audio 416 played within the first virtual shared environment 106, e.g., via the virtual speaker 440. For various embodiments, the accompanying audio 416 is one or more of a pre-designated sound such as a beep, chirp, clap, snap, chime, buzz, etc. In some embodiments these pre-designated sound(s) occur intermittently.

The accompanying audio 416 helps form the distinguishing sensory attribute for the audio-accompanied chair 414 geometric volumetric overlay by being distinct from other sounds that are being presented within the first virtual shared environment 106. FIG. 4 shows in this example that the accompanying audio 416 emanates from a spatial position at or near the spatial location of the geometric volumetric overlay of the audio-accompanied chair 414 within the first virtual shared environment 106. This positioning helps the listeners better associate the accompanying audio 416 as having a presentation relation to the audio-accompanied chair 414.

The accompanying audio 416 helps the virtual environment participants recognize that this enhancement is a supplemental content enhancement and not a structured portion of the first virtual shared environment 106. For example, due to the accompanying audio 416 the first and second avatars 110a, 110b better are able to recognize that they should not virtually sit on the audio-accompanied chair 414 but instead that this audio-accompanied chair 414 is being presented within the first virtual shared environment 106 in order to help illustrate the story that is being told by the third avatar 110c. In other embodiments, the enhancements such as the audio-accompanied chair 414 allow virtual interaction with participants within the respective virtual shared environment. For example, in other embodiments if the third avatar 110c is describing physical aspects of the audio-accompanied chair 414 one of the other avatars is able to virtually sit on the audio-accompanied chair 414 in order to better appreciate the description that is being given by the third avatar 110c. The virtual reality equipment used by a user to participate in the virtual environment in some embodiments include one or more tactile sensors which provide feedback to mimic the physical sensation that would be present if the user were physical engaging (e.g., sitting on) such a chair in the physical world.

FIG. 5 illustrates a fifth enhanced virtual environment scene 500 in which a virtual environment enhancement with one or more distinguishing sensory attributes is presented. The fifth enhanced virtual environment scene 500 includes many components that are shared with the first, second, third, and fourth enhanced virtual environment scenes 100, 200, 300, 400 so that many common reference numerals are used in all of FIGS. 1-4 and FIG. 5. The same virtual shared environment 106 is depicted in all of FIGS. 1-5, although some individual components within the respective virtual shared environment have changed which is consistent with the regularly changing nature of a virtual shared environment.

For virtual environment enhancement in the fifth enhanced virtual environment scene 500 shown in FIG. 5, the virtual sensor 108 senses that the third avatar 110c is again telling a story about a recent experience that the third avatar 110c and/or the third user 102c experienced. The third avatar 110c speaks second words 512 within the first virtual shared environment 106 describing a new song from a particular music artist that the third avatar 110c and/or the third user 102c recently heard. The virtual sensor 108 includes a word sensing component such as a virtual microphone and/or a virtual camera which can read words presented visually within the first virtual shared environment 106. The virtual sensor 108 inputs the captured words into a machine learning model associated with the first virtual shared environment 106. The machine learning model as output produces an indication that the second words 512 constitute and/or include a trigger signal for producing supplemental media content to supplement the event. The event in this case is the third avatar 110c telling a story about the new song. Based on the monitored information being designated as trigger information, the collected information related to the event is input into artificial intelligence which in response generates media content related to the event. FIG. 5 shows that the artificial intelligence generated media content for a virtual environment enhancement that is sole audio content 514 that is presented within the first virtual shared environment 106 so as to be able to be heard by various participants such as the first, second, and/or third avatars 110a, 110b, 110c within the first virtual shared environment 106.

The “sole” of the sole audio content 514 refers to this embodiment not including a generative volumetric overlay to accompany the sole audio content 514. After being generated via the artificial intelligence media content generator, the sole audio content 514 is modified via the sensory distinguishing module to further include a distinguishing audio sensory attribute to distinguish this audio from other audio within the first virtual shared environment 106. A distinguishing sound 515 such as one or more of a beep, chirp, clap, snap, chime, buzz, etc. that occurs preceding, following, and/or intermittently throughout a contextual sound enhancement such as the sole audio content 514. The distinguishing sound 515 may occur intermittently and/or at a beginning of the enhancement presentation before a contextual related audio clip is played. For example, a beep (which may be the distinguishing sound 515) is played initially and then contextual audio such as the actual song (which may be the sole audio content 514) which the third avatar 110c is describing plays after the initial enhancement commencement sound that is the distinguishing sound 515.

In the fifth virtual scene 500 depicted in FIG. 5 the sole audio content 514 includes a distinguishing sound 515 of a chirp followed by the actual musical audio of the song that is being described by the third avatar 110c with the second words 512. The distinguishing sound 515 acts as an initial enhancement commencement sound, has an attention-grabbing characteristic, and indicates to the virtual audience that the following sound to be played (the sole audio content 514, e.g., the pop artist song by singer KL according to FIG. 5) is not spontaneously being played as part of the natural virtual world but rather is being presented to enhance and supplement the event (e.g., the telling of a story) that has been recognized as having begun (told by the third avatar 110c) within the virtual shared environment 106.

In some embodiments, the distinguishing sound 515 is presented with a timing placement selected by the virtual environment enhancement program 816 so that interference of the distinguishing sound 515 with the sole audio content 514 and/or words spoken by the storyteller/virtual world presenter, e.g., the third avatar 110c, is reduced. The virtual environment enhancement program 816 can generate an audio sequence of the distinguishing sound 515 and sole audio content 514 combination so that the two do not overlap. In some embodiments, the virtual environment enhancement program 816 also generates the distinguishing sound 515 to be at a higher or lower pitch and/or octave than the sole audio content 514 and/or the storyteller voice so that the distinguishing sound 515 is more distinct compared to one or both of the other two.

FIG. 6 illustrates an enhancement mode notification scene 600 that according to at least one embodiments may occur in one or more of the first, second, third, fourth, and/or fifth virtual environment scenes 100, 200, 300, 400, 500 described previously with respect to FIGS. 1-5. The sixth enhanced virtual environment scene 600 includes many components that are shared with the first, second, third, fourth, and fifth enhanced virtual environment scenes 100, 200, 300, 400, 500 so that many common reference numerals are used in all of FIGS. 1-5 and FIG. 6. The same virtual shared environment 106 is depicted in all of FIGS. 1-6, although some individual components within the respective virtual shared environment have changed and/or are not present which is consistent with the regularly changing nature of a virtual shared environment.

To enable the virtual environment enhancement depicted in the other drawings, in some embodiments the respective virtual shared environment includes presentation of a message within the respective virtual shared environment that notifies the virtual participants of a particular enhancement sensory attribute to be used. FIG. 6 shows that enhancement mode notification scene 600 includes a presented attribute message 630 which indicates which attribute will be present for a virtual environment enhancement as described herein. In the specific example of FIG. 6, the presented attribute message 630 indicates that “transparency” is the distinguishing sensory attribute. Thus, the presented attribute message 630 shown in FIG. 6 corresponds to the use of a transparent geometric volumetric overlay like the transparent first chair 114 shown in FIG. 1. Other messages such as scaling (larger or smaller), designated location (within a thought bubble), and/or presence and type of audio would be presented in the presented attribute message 630 for other embodiments to correspond to those depicted in FIGS. 2, 3, and 4-5, respectively. By becoming aware of the distinguishing sensory attribute to be used, the virtual environment participants such as the first and second avatars 110a, 110b can recognize the subsequent use of virtual environment enhancement that matches and includes the one or more distinguishing sensory attributes indicated in the presented attribute message 630. Although FIG. 6 shows a single enhancement sensory attribute (transparency) being displayed as the presented attribute message 630, in other embodiments the presented attribute message 630 includes multiple attributes which can each be used separately or in combination for the virtual environment session for indicating virtual environment enhancement.

A computer system with the virtual environment enhancement program 816 operates as a special purpose computer system in which the virtual environment enhancement program 816 assists in improving the immersive content experience of a virtual environment. In particular, the virtual environment enhancement program 816 transforms a computer system into a special purpose computer system as compared to currently available general computer systems that do not have the virtual environment enhancement program.

It should be appreciated that FIGS. 1-6 provide only illustrations of some environments or implementations and do not imply any limitations with regard to the environments and/or sequences in which different embodiments may be implemented. Many modifications to the depicted environments may be made based on design and implementation requirements. Various embodiments include the combination of one or more of the features described above for the various FIGS. 1-6.

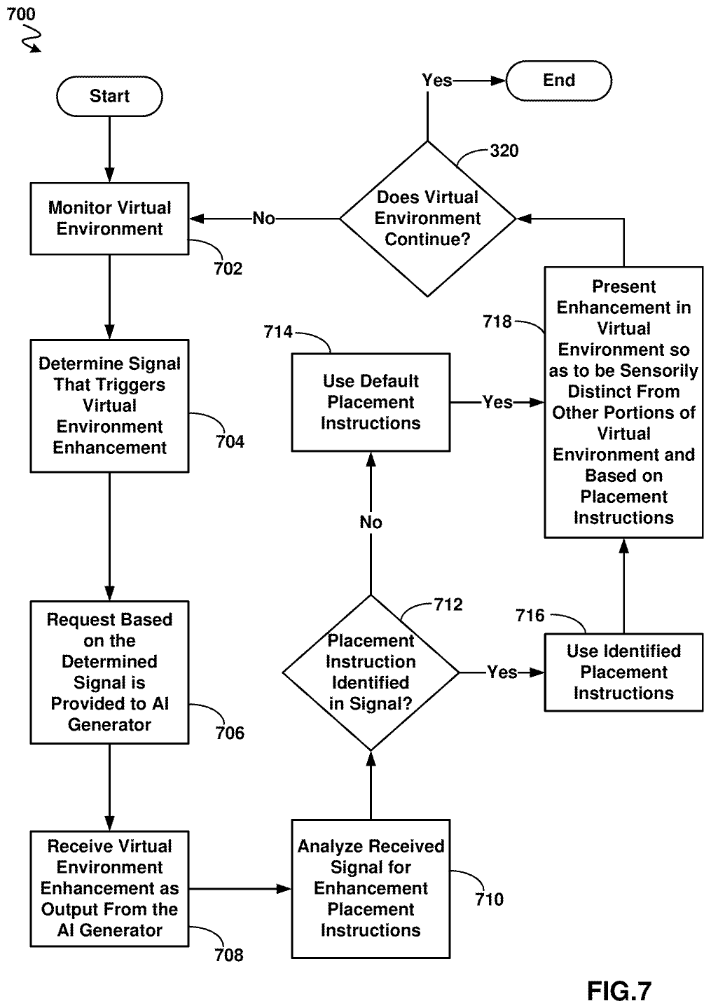

FIG. 7 is an operational flowchart illustrating a virtual environment enhancement process 700 according to at least one embodiment. Various aspects of the virtual environment enhancement process 700 are illustrated in the previously described embodiments shown in FIGS. 1-6. In at least some embodiments, a virtual environment enhancement program 816 shown in FIG. 8 and described below is involved in the performance of the virtual environment enhancement process 700.

In a step 702 of the virtual environment enhancement process 700, a virtual environment is monitored. In at least some embodiments, step 702 is performed via one or more virtual sensors such as the virtual sensor 108 that was shown in FIGS. 1-6 and described earlier. In some embodiments, the virtual environment monitoring of step 702 occurs as the virtual environment enhancement program 816 gains application programming interface access with the software programs running the entire virtual shared environment. Thus, various events such as the presenting of words, gestures, and/or other virtual environment changes that occur within the virtual environment leave a digital trail that can be recognized via the virtual environment enhancement program 816. In some embodiments, digital data from the computer programs that are operating the virtual environment are transmitted to the virtual environment enhancement program 816 to enable the virtual environment enhancement program 816 to perform the monitoring. In some embodiments, the virtual environment enhancement program 816 is a supplemental part of the software programs that operate the virtual shared environment so that a data transmission for data monitoring can occur within a computer and/or within intricately connected computers so that data transmission length is reduced.

In a step 704 of the virtual environment enhancement process 700, a signal is determined that triggers virtual environment enhancement. The signal of step 704 is obtained from the virtual environment that is being monitored in step 702. In some embodiments, step 704 includes performing natural language processing on text such as spoken or displayed words that are presented within the virtual environment. In some embodiments, speech-to-text transcription is performed on audio words that are captured from the determined signals within the virtual environment. Such speech-to-text transcription uses linguistic algorithms to sort auditory signals and convert the audio signals into text such as Unicode text. Other natural language processing is then performed on the produced text. Various captured signals such as text, images, audio, and/or virtual environment metadata are input into one or more machine learning models to identify any signals for triggering the virtual environment enhancement. In some embodiments, the audio and/or images that are recorded represent virtual environment character interaction of virtual environment characters within the virtual environment. For example, the virtual environment enhancement program recognizes multiple distinct voices indicating that a conversation is taking place in order to proceed further with the virtual environment enhancement and generate and present the virtual environment enhancement. Such confirmation of a conversation might be used by the virtual environment enhancement program 816, because the virtual environment enhancement program 816 might make a resource preserving choice to not generate the virtual environment enhancement if no other person/avatar is in the virtual vicinity to hear the story of the avatar. In some embodiments similar to the audio confirmation of a conversation amongst multiple parties, an image confirmation of other avatars being physically present within the virtual vicinity (e.g., within a pre-determined distance threshold) is used as a confirmation to proceed with virtual environment enhancement. In some embodiments the one or more machine learning models are trained in a supervised manner by having various input data (text, images, metadata, etc.) and labels of “signal” indicators that accompany certain input data. The identification of a trigger signal in step 704 causes the virtual environment enhancement process 700 to proceed to step 706 to evaluate the signal and/or to evaluate a request that is based on the determined signal. In a simpler embodiment, words are monitored and compared to a look-up table and a match in the look-up table to a word designated as a trigger word achieves the triggering of step 704.

In a step 706 of the virtual environment enhancement process 700, a request that is based on the determined signal is provided to an artificial intelligence media content generator. The determined signal refers to the signal determined in step 704. In some embodiments, the determined signal itself is input as the request into the artificial intelligence media content generator. In other embodiments, the identified signal points to a content creation request which represents the desired content and is provided to the artificial intelligence media content generator. In at least some embodiments, the virtual environment enhancement program 816 performs semantic analysis NLP on the signals that are received in order to produce a request for specific content that semantically matches the signals. For example, the virtual environment enhancement program 816 performs semantic word vector analysis, e.g., with cosine similarity comparison, on vectors for words received in the signal to determine appropriate specific media content that should be generated to enhance the event.

In at least some embodiments the artificial intelligence media content generator is part of or accessible to the virtual environment enhancement program 816 and produces media content for virtual environment enhancements based on input data such as input text. The virtual environment enhancements in at least some embodiments include generative volumetric overlays that appear with three-dimensions when stitched into the virtual environment. In some embodiments, the virtual environment enhancements include audio components. The artificial intelligence media content generator is trained to use multiple different image views of an object to stitch together a three-dimensional representation of the object. In some embodiments, the artificial intelligence media content generator accesses large-scale repositories of three-dimensional CAD models to produce the generative volumetric overlays. In some embodiments, the artificial intelligence media content generator is trained by scoring random image views of objects with frozen pretrained image and text encoders trained on web images and alt-text. In some embodiments, the artificial intelligence media content generator implements geometric priors including sparsity-inducing transmittance regularization scene bounds and multilayer perceptron architectures. In at least some embodiments, the artificial intelligence media content generator implements point clouds, voxel grids, triangle meshes, generative adversarial networks, neural rendering, delayed neural rendering, feature extraction, image landmarking, and/or image reconstruction to produce three-dimensional visual content and texture.

In some embodiments, a hidden-layer diffusion model is used that is conditioned on a multi-category shape vector to produce 3D volumetric presentations from 2D image inputs. In some embodiments, a diffusion and denoising process in a pixel space is transformed into operations in a neural radiance field parameter space in which an entire volume space is represented with a continuous function parameterized by a multilayer perceptron. In some embodiments, the artificial intelligence media content generator uses a text-to-3D algorithm to generate a generative volumetric overlay in response to receiving words and based on words that were captured from the virtual shared environment. In some embodiments, a control shape of a limit subdivided surface is obtained along with a texture map and a normal map, optimization on mesh parameters is performed directly, and these elements are used to produce a 3D volumetric presentation with plausible meshes and textures starting from a text embedding. In some embodiments, the artificial intelligence media content generator is divided into a text-to-multiple views generation module and a multiple views-to-3D model generation module. In some embodiments, the artificial intelligence media content generator uses a dynamic neural radiance field which is optimized for scene appearance, motion consistency, and density using a model trained on text-image pairs.

In some embodiments, the virtual environment enhancement program 816 performs web-scraping to obtain images that correspond to certain text and those images are input into the artificial intelligence media content generator to produce the generative volumetric overlays. For example, the virtual environment enhancement program 816 recognizes a story being told within the virtual shared environment about a chair, analyzes the words of the story to identify details about the chair, and uses the details identified to find pictures of the chair from the internet. The so-obtained pictures/images are then used to produce the volumetric media content to project for visual observation within the three-dimensional virtual environment.

In some embodiments, the artificial intelligence media content generator is trained for customization with respect to particular users. In some embodiments, the artificial intelligence media content generator is trained with images of the acquaintances of the user. These images are accessed to generate generative volumetric overlays depicting the acquaintances. Images of individuals are used subject to obtaining appropriate consent according to governing privacy laws. Such generative volumetric overlays depicting particular people are produced in some embodiments to illustrate stories being told about these people. When the monitored signals are provided, received, and determined that they relate to a story about acquaintances of a virtual storyteller, in response a virtual environment enhancement showing images and/or voices of these acquaintances are produced. These generative volumetric overlays of people constitute 3D actors that act out a story being told within the virtual environment. Some embodiments also include (subject to legally required consent being obtained) capturing and storing voices of the acquaintances for use with/as the virtual environment enhancements. In some instances, as the story evolves to indicate different actions being performed by the people the generative volumetric overlay is updated to match the new different actions that are being explained in the story. In some instances, a user customizes the artificial intelligence media content generator by providing, e.g., uploading, one or more digital images of an object which the user would like to use to produce a generative volumetric overlay to be displayed within the virtual environment as presented herein.

In a step 708 of the virtual environment enhancement process 700, one or more virtual environment enhancements are received as output from the artificial intelligence media content generator. The artificial intelligence media content generator refers to that component to which the request was provided in step 706. Examples of the virtual environment enhancements were the basic chairs and/or accompanying audio provided above in describing the embodiments shown in FIGS. 1-5. In some embodiments, the one or more virtual environment enhancements include generative volumetric overlays which include visible components. In some embodiments, the one or more virtual environment enhancements include audio aspects which supplement or replace the (visible) generative volumetric overlays. In some embodiments, the output includes one or more optional generation attributes. The output is set up for post-processing to facilitate improved merging of the output into the virtual environment and for the generated media content to receive one or more sensory distinguishing attributes before presentation as will be described with respect to step 718. Such post-processing and merging is in some embodiments carried out in step 718 which will be described subsequently.

In a step 710 of the virtual environment enhancement process 700, the determined signal is analyzed for placement instructions. The determined signal refers to the signal that was determined in step 704. In some embodiments, step 710 includes inputting the determined signal into another machine learning model that is trained to identify placement instructions within the monitored data. In some embodiments this machine learning models is trained in a supervised manner by having various input data (text, images, metadata, etc.) and labels of “placement instruction” indicators that accompany certain input data. For example, an avatar speaking within the virtual environment says that the enhancement should be positioned within a thought bubble for this avatar. The virtual environment enhancement program 816 recognizes that provided instruction and in response generates the virtual environment enhancement within the thought bubble. In another example, in one instance an avatar shares a story about a bird or a flying experience and the virtual environment enhancement program 816 recognizes a schematic environmental element of the story as being related to the air or sky and in response generates the virtual environment enhancement to be presented above the storyteller (so as to appear as occurring within the higher air or sky) within the virtual environment. The machine learning model recognizes this word instruction as a placement instruction. The virtual environment enhancement program 816 receives data from the software program hosting the virtual environment in order to perform step 710. In some embodiments this data analyzed for step 710 is the same data that is analyzed as part of steps 704 and/or 706 to identify a trigger signal and to identify a content creation request for the artificial intelligence media content generator.

In a step 712 of the virtual environment enhancement process 700, a determination is made as to whether one or more placement instructions is identified in the signal. If the determination of step 712 is negative and no placement instruction is identified within the signal, then the virtual environment enhancement process 700 proceeds to step 714. If the determination of step 712 is affirmative and one or more placement instructions are identified within the signal, then the virtual environment enhancement process 700 proceeds to step 716. In some embodiments, the determination of step 712 may be performed using a machine learning model which receives virtual environment data as input and in response as output gives a determination as to whether placement instructions for the virtual environment enhancement has been provided.

In a step 714 of the virtual environment enhancement process 700, default placement instructions are used. In some embodiments, the default placement instructions are customized according to a virtual environment participant who provided the trigger signal. In a preliminary or registration step, the participant provides in a graphical user interface, generated by the virtual environment program, information about the desired virtual environment traits for the user such as virtual environment enhancement placements. In some embodiments, the default placement instructions are for the user thought bubble or another visually, e.g., linearly, demarcated area within the virtual shared environment which is sized to hold a generative volumetric overlay. In some embodiments, the default placement occurs via the virtual environment enhancement program 816 sensing the position of current objects such as other avatars listening to a story within the virtual environment and selects the placement according to a free position, e.g., a nearest free position, to the speaker/enhancement trigger provider. The free position refers to a position that is not currently being occupied by an avatar or virtual environment visual structure within the virtual environment. In some embodiments, the default placement instructions is further specified by the virtual sensors and the virtual environment enhancement program 816 identifying listeners (e.g., virtual participants) to a story or presentation, identifying the positions of those listeners, and then choosing the enhancement placement for a position which maximizes visibility of the enhancement with respect to those listeners. The default placement instructions are combined with the instructions for generating the virtual environment enhancement so that the combination of these (content plus location) are usable in step 718.

In a step 716 of the virtual environment enhancement process 700, identified placement instructions are used. These placement instructions refer to those identified in steps 710 and 712. The identified placement instructions are combined with the instructions for generating the virtual environment enhancement so that the combination of these (content plus location) are usable in step 718.

In a step 718 of the virtual environment enhancement process 700, the enhancement is presented in the virtual environment so as to be sensorily distinct from other portions of the virtual environment and based on the placement instructions. The enhancement refers to the media content output from the artificial intelligence media content generator that was received in step 708. In at least some embodiments, step 718 is performed via inputting the media content output from step 708 into a sensory distinguishing module which adjusts the media content to imbue the media content with a sensory distinguishing attribute. The sensory distinguishing attribute of the enhancement(s) include one or more of a transparency factor, a scaling factor, a location factor, an accompanying audio factor, an audio factor, and a color factor as compared to other portions of the virtual shared environment. The sensory distinguishing module implements various media content producing techniques to imbue the change in transparency, size, location etc. FIGS. 1-5 depicted such distinguishing sensory attributes for the generated supplementary media content. The placement instructions refer to those used via either step 714 or via step 716. In some embodiments, the placement instructions are for a generative volumetric overlay to be placed in front of the speaking avatar, e.g., positioned in between the speaking avatar and the listening avatars.

FIGS. 1-5 described above illustrate various examples of step 718 of the virtual environment enhancements being presented with the one or more sensory distinguishing attributes within the virtual shared environment 106. For example, in FIG. 1 the transparent chair 114 was presented as a generative volumetric overlay as the virtual environment enhancement in a location near the speaking third avatar 110c in a position that is visible to the listening first and second avatars 110a, 110b. In FIG. 2, the enlarged chair 214 was presented as a generative volumetric overlay as the virtual environment enhancement in a location near the speaking third avatar 110c in a position that is visible to the listening first and second avatars 110a, 110b. In FIG. 3, the chair volumetric content 314 was presented as a generative volumetric overlay as the virtual environment enhancement in the designated (e.g., visually demarcated) location that is a thought bubble 316 associated with the speaking avatar 110c. In some embodiments the thought bubble includes an arrow portion pointing to the avatar whose story is being depicted within the thought bubble. In some embodiments the virtual environment enhancement program 816 positions the thought bubble in a position (e.g., pointing centered and straight above the speaker, offset diagonally to the right of the speaker, or offset diagonally to the left of the speaker) to maximize visibility of the virtual environment participants who are listening to the story. In FIG. 4, the audio-accompanied chair 414 was presented as a generative volumetric overlay as the virtual environment enhancement with audio in a location near the speaking avatar 110c. The audio-accompanied chair 414 is positioned near the third avatar 110c and the speaker 440 which plays the audio 416 is positioned so that the audio 416 emanates from a position near the generative volumetric overlay of the audio-accompanied chair 414 within the virtual shared environment 416. In FIG. 5, the sole audio content 514 is presented as the virtual environment enhancement and is played from a speaker which plays the sole audio content 514 and is positioned so that the sole audio content 514 emanates from a position that is separated somewhat from the speaking third avatar 110c so that voice of the third avatar 110c is able to be better distinguished from the sole audio content 514. The distinguishing sound 515 is added to the sole audio content 514 to help the virtual listeners be aware that the sole audio content 514 is enhancement content for the virtual shared environment 106 and not a naturally occurring feature of the virtual shared environment 106.

In some embodiments, the visual environment enhancement that is presented in the virtual shared environment evolves and changed over time during the presenting and based on updates to the one or more events that are occurring. For example, if a story being told by a virtual environment transitions to a different segment, the virtual environment program 816 continues to monitor the virtual environment content to identify changes for the virtual environment enhancement. For example, in the various embodiments shown with a generative volumetric overlay of a chair presented in the virtual shared environment and the speaker continues to speak about another object and/or person, the virtual environment program 816 generates another virtual environment enhancement to represent the new object and/or person and presents this new virtual environment enhancement in addition to the chair virtual environment enhancement. In some embodiments a user explains about different color and/or material (textile) used for the chair that he saw and the virtual environment program 816 updates the generative volumetric overlay to have the newly mentioned color and/or material for viewing and/or virtual touching by the virtual audience.

In some embodiments, the supplemental enhancement components have the same sensorily distinct attribute that the chair had. For example, for the transparent chair 114 a supplemental image of a person next to the chair (who is part of the story/presentation by the storyteller) also is generated with a transparency factor that the 3D presentation of the person is more transparent than other elements of the virtual shared environment 106. In some embodiments, the supplemental enhancement components also appear within a designated location (e.g., within the visually demarcated area, e.g., the particular thought bubble) shared by the 3D chair presentation. In some embodiments, the supplemental virtual environment enhancement has one or more different sensory distinguishing attributes compared to the chair that are still distinct compared to remaining portions of the virtual shared environment, e.g., the chair is more transparent than the surroundings and a non-transparent 3D presentation of a person next to the chair is generated with some supplemental audio indication (e.g., a chirp, a beep, a narrator voice, etc.). The supplemental audio sound indicates that the person volumetric image is also an enhancement and not a main standard part of the virtual shared environment, e.g., not an actual avatar who is listening and can spontaneously respond using the thought patterns of the person being represented. Thus, in some embodiments the virtual environment media content enhancement evolves over time based on the continuation of the one or more events. In other embodiments, however, the initial virtual environment media content enhancement maintains the same form and does not evolve over time within the virtual shared environment.

In a step 720 of the virtual environment enhancement process 700, a determination is made as to whether the virtual environment continues. If the determination of step 720 is negative and the virtual environment does not continue, then the virtual environment enhancement process 700 ends. If the determination of step 712 is affirmative and the virtual environment continues, then the virtual environment enhancement process 700 proceeds to step 702 for further monitoring of the virtual environment for a possibility to generate further suitable and sensorily distinct virtual environment enhancements.

In some embodiments, the virtual sensor and virtual environment program 816 facilitate revoking of a presented virtual environment enhancement. The virtual sensor senses and identifies another event such as a second predetermined signal which causes the virtual environment program 816 to revoke and remove the previously presented media content that was the virtual environment enhancement. Thereafter, an additional, e.g., a third, signal is received from the virtual environment e.g., via a further word provided and/or movement, e.g., gesture made. The third signal is detected and decoded via the virtual environment enhancement program 816 and a new virtual environment enhancement is generated via the artificial intelligence media content generator and based on the new third signal that is received. The new virtual environment enhancement that is media content shares one or more elements with the media content of the previous virtual environment enhancement that was revoked. Thus, the new virtual environment enhancement constitutes an evolution of the virtual environment enhancement. In at least some embodiments the first evolved media content is further supplemented, e.g., via a sensory distinguishing module of the virtual environment enhancement program 816 to include one or more distinguishing sensory attributes distinguishing the evolved media content from remaining portions of the virtual environment (see exemplary distinguishing sensory attributes described for the main enhancement throughout this disclosure). In some embodiments, for consistency the evolved media content maintains the one or more distinguishing sensory attributes that the original virtual environment enhancement had. In some embodiments, the evolved media content includes at least one different distinguishing sensory attribute as compared to the one or more distinguishing sensory attributes that the original virtual environment enhancement had.

In various embodiments the one or more machine learning models involved in the virtual environment enhancement process 700 include one or more of naive Bayes models, random decision tree models, linear statistical query models, logistic regression n models, neural network models, e.g. convolutional neural networks, multi-layer perceptrons, residual networks, long short-term memory architectures, algorithms, deep learning models, deep learning generative models, and other machine learning models. Training data includes samples of trigger signals, placement instructions, and specific content creation request instructions. The learning algorithm, which is trained in the machine learning models in question, finds patterns in input data about the samples in order to map the input data attributes to the target. The trained machine learning models contain or otherwise utilize these patterns so that the recommendations and recognition can be predicted for similar future inputs. A machine learning model may be used to obtain predictions on new trigger signals, placement instructions, enhancement type instructions, and instructions to create specific content for the virtual environment. The machine learning model uses the patterns that are identified to determine what the appropriate recognition and generation decisions are for future data to be received and analyzed. As samples are being provided, training of the one or more machine learning models may include supervised learning by submitting prior data sets to an untrained or previously trained machine learning model. In some instances, unsupervised and/or semi-supervised learning for the one or more machine learning models may also be implemented.

It may be appreciated that FIG. 7 provides illustrations of some embodiments and does not imply any limitations with regard to how different embodiments may be implemented. Many modifications to the depicted embodiment(s), e.g. to a depicted sequence of steps, may be made based on design and implementation requirements.

Various aspects of the present disclosure are described by narrative text, flowcharts. block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 shown in FIG. 8 contains an example of an environment for the execution of at least some of the computer code involved in performing the inventive methods, such as virtual environment enhancement program 816. In addition to virtual environment enhancement program 816, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and virtual environment enhancement program 816, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all. of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in virtual environment enhancement program 816 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in virtual environment enhancement program 816 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, haptic devices, and virtual reality devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing exceptionally large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815. The network module 815 includes the software, hardware, and firmware necessary for communication with 5G NR signals.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers. For the micro-cell implemented in the present embodiments, a 5G NR network communication in a micro-cell or micro-MEC is used for the functions of the virtual environment enhancement program 816.

END USER DEVICE (EUD) 803 is any computer system that is used and controlled by an end user (for example, a customer of an enterprise that operates computer 801) and may take any of the forms discussed above in connection with computer 801. EUD 803 typically receives helpful and useful data from the operations of computer 801. For example, in a hypothetical case where computer 801 is designed to provide a natural language processing result to an end user, this result would typically be communicated from network module 815 of computer 801 through WAN 802 to EUD 803. In this way, EUD 803 can display, or otherwise present, the result to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration. management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method for virtual environment enhancement, the computer-implemented method comprising:
determining a signal from one or more events in a virtual environment;
in response to the determined signal triggering virtual environment enhancement, inputting a request based on the determined signal to at least one generative artificial intelligence model that in response produces media content; and
presenting the media content within the virtual environment such that the media content comprises one or more distinguishing sensory attributes distinguishing the media content from remaining portions of the virtual environment.

2. The computer-implemented method of claim 1, wherein the media content comprises volumetric content and the presenting comprises displaying the volumetric content within the virtual environment.

3. The computer-implemented method of claim 2, wherein the one or more distinguishing sensory attributes of the volumetric content include at least one member selected from a group consisting of a transparency factor, a scaling factor, a location factor, and a color factor.

4. The computer-implemented method of claim 2, wherein the one or more distinguishing sensory attributes comprises a transparency factor of the volumetric content that is different from a transparency factor of portions of the virtual environment surrounding the volumetric content.

5. The computer-implemented method of claim 2, wherein the one or more distinguishing sensory attributes comprises a scaling factor of the volumetric content that is higher or lower than a scaling factor of elements of the virtual environment surrounding the volumetric content.

6. The computer-implemented method of claim 2, wherein the one or more distinguishing sensory attributes comprises a location factor of the volumetric content such that the volumetric content is displayed within a visually demarcated portion of the virtual environment that separates the volumetric content from the remaining portions of the virtual environment.

7. The computer-implemented method of claim 6, wherein the visually demarcated portion comprises a thought bubble associated with one or more characters within the virtual environment.

8. The computer-implemented method of claim 1, wherein the media content presented in the virtual environment changes over time during the presenting.

9. The computer-implemented method of claim 1, wherein the media content presented in the virtual environment comprises audio content.

10. The computer-implemented method of claim 1, further comprising:
responsive to identifying a second predetermined signal, revoking the media content;
detecting and decoding a third signal from the virtual environment;
evolving the media content based on the third signal and thereby producing first evolved media content, the first evolved media content sharing one or more elements with the revoked media content; and
presenting the first evolved media content within the virtual environment such that the first evolved media content comprises one or more distinguishing sensory attributes distinguishing the first evolved media content from the remaining portions of the virtual environment.

11. The computer-implemented method of claim 1, further comprising determining a placement of the presentation of the media content within the virtual environment based on the determined signal.

12. The computer-implemented method of claim 11, wherein:
the media content comprises a volumetric content and the presenting comprises a display of the volumetric content within the virtual environment; and
the placement of the presentation comprises a location placement of the volumetric content within the virtual environment.

13. The computer-implemented method of claim 1, wherein:
the media content comprises audio content and the presenting comprises playing of the audio for the virtual environment; and
a placement of the presentation comprises at least one member selected from a group consisting of a location placement for dissemination of the audio content within the virtual environment, a timing placement for the audio content, and a pitch placement for the audio content.

14. The computer-implemented method of claim 1, wherein the media content is presented in a default location placement within the virtual environment.

15. The computer-implemented method of claim 1, wherein the one or more distinguishing sensory attributes match a message that was presented within the virtual environment and that indicated the one or more distinguishing sensory attributes.

16. The computer-implemented method of claim 1, wherein the one or more events in the virtual environment are selected from a group consisting of audio, a movement, virtual environment character interaction, and virtual environment metadata.

17. A computer system for virtual environment enhancement, the computer system comprising:
one or more processors, one or more computer-readable tangible storage media, and program instructions stored on at least one of the one or more computer-readable tangible storage media for execution by at least one of the one or more processors to cause the computer system to:
determine a signal from one or more events in a virtual environment;
in response to the determined signal triggering virtual environment enhancement, input a request based on the determined signal to at least one generative artificial intelligence model that in response produces media content; and
present the media content within the virtual environment such that the media content comprises one or more distinguishing sensory attributes distinguishing the media content from remaining portions of the virtual environment.

18. The computer system of claim 17, wherein the media content comprises volumetric content and the presenting comprises displaying the volumetric content within the virtual environment.

19. A computer program product for virtual environment enhancement, the computer program product comprising a computer-readable storage medium having program instructions embodied therewith, the program instructions being executable by a computer to cause the computer to:
determine a signal from one or more events in a virtual environment;
in response to the determined signal triggering virtual environment enhancement, input a request based on the determined signal to at least one generative artificial intelligence model that in response produces media content; and
present the media content within the virtual environment such that the media content comprises one or more distinguishing sensory attributes distinguishing the media content from remaining portions of the virtual environment.

20. The computer program product of claim 19, wherein the media content comprises volumetric content and the presenting comprises displaying the volumetric content within the virtual environment.
